(19) United States
(12) Patent Application Publication
(10) Pub. No.: US 2018/0182434 A1
(43) Pub. Date: Jun. 28, 2018

(54) METHODS FOR GENERATING VIDEO PREVIEWS USING FEATURE-DRIVEN SELECTION OF VIDEO FRAGMENTS

(71) Applicant: Machine Learning Works, LLC, San Francisco, CA (US)

(72) Inventors: Aleksei Esin, Sochi (RU); Dmitry Matov, Sochi (RU); Grigorii Fefelov, Sochi (RU); Eugene Krokhalev, Sochi (RU)

(21) Appl. No.: 15/391,089

(22) Filed: Dec. 27, 2016

(51) Int. Cl. G11B 27/031; G06K 9/00; G11B 27/10

(52) U.S. Cl. CPC G11B 27/031; G06K 9/00744; G11B 27/10; G06K 9/00369; G06K 9/00718

(57) ABSTRACT

Methods and systems for generating video previews are provided. In one embodiment, a method includes acquiring a video. The method allows extracting features of the video. The method further includes determining, based on the features, a genre of the video. The method can proceed with selecting, based on the features and the genre, a time fragment of the video. The method further includes cropping the time fragment to a rectangular shape to fit a screen of a mobile device positioned vertically. The method further includes compressing the cropped fragment into low bitrate video fragment.

### BACKGROUND

### Technical Field

This disclosure generally relates to input arrangements for interaction between a user and a computer. More particularly, this disclosure relates to methods and systems for generating video previews based on a selection of video fragment using audio and video features of the video.

### Description of Related Art

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Mobile devices with touchscreens, including smartphones, tablet computers, and portable media players, are popular for watching video content. These devices typically use software applications designed to receive (e.g., stream or download) video content and output the video content via a display. Some software applications provide a list of videos in response to a user query. Typically, the videos are located at remote computing resource locations and can be played back on the mobile device per user request. It is desirable to provide short previews of videos on the screen of the mobile device prior to streaming or downloading the full version of video. This may enable the users to select a video to be played back in full on the mobile device. Therefore, there is a need for an automatic generation of previews for a plurality of videos to facilitate selection of a video.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

In one aspect of this disclosure, a method for generating video preview is provided. The method may include acquiring a video and extracting features of the video. The method may allow determining, based on the features, a genre of the video. The method may further include selecting, based on the features and the genre, a time fragment of the video.

In some embodiments, selecting the time fragment includes selecting portions of the video and determining features of at least one portion of the portions. A rank of each of the portion may be further determined based on features of the portion. The highest ranked portion can be further determined and designated as the selected time fragment.

In some embodiments, the features of the portion of the video include high-level audio features. The high-level audio features may include Mel-frequency cepstral coefficients (MFCC). The rank of the portion of video can be determined based on a difference between the high-level audio features determined inside and outside the one portion.

The rank of the at least one portion may be also determined based on a ratio of dispersions of the high-level audio features determined for the first few seconds of the portion and the part of video preceding the portion.

In some embodiments, the rank of the portion can be determined based on the presence of images of people in the portion.

In some embodiments, the method may include cropping the time fragment to a rectangular shape. An aspect ratio of the rectangular shape is based on an aspect ratio of a screen of a mobile device positioned vertically.

In some embodiments, the method may further include compressing, using a predetermined video format, the cropped fragment into a low bitrate video fragment. In some embodiments, the low bitrate video fragment may lack bi-directionally predicted frames and audio interleaved with video in short intervals.

In some embodiments, a duration of the time fragment is in the range between 7 seconds to 20 seconds.

In another aspect of this disclosure, a system for generating video previews is provided. The system comprises at least one processor, a memory storing processor-executable codes, and a touchscreen display, wherein the at least one processor is configured to implement the following operations upon executing the processor-executable codes: acquiring a video; extracting features of the video; determining, based on the features, a genre of the video; and selecting, based on the features and the genre, a time fragment of the video.

In yet another aspect of this disclosure, there is provided a non-transitory processor-readable medium having instructions stored thereon. When the instructions are executed by one or more processors, the instructions cause the one or more processors to implement a method for controlling video playback, the method including acquiring a video; extracting features of the video; determining, based on the features, a genre of the video; and selecting, based on the features and the genre, a time fragment of the video.

Additional objects, advantages, and novel features of the examples will be set forth in part in the description, which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram showing an example embodiment of a computer environment for implementing methods for generating video previews.

FIG. 2 is a block diagram showing an example process for generating a video preview.

FIG. 3 is a block diagram showing a video preview generation system.

FIG. 4 shows an example video and a video preview.

FIG. 5 is a flow chart showing a method for generating a video preview, according to an example embodiment.

FIG. 6 is a block diagram showing a computer system that can be used to implement the methods for generating video previews.

### DETAILED DESCRIPTION OF EXAMPLE EMBODIMENTS

Embodiments described herein generally provide methods and systems for generating video previews. Embodiments of the present disclosure may be used to present a short preview of a video on a mobile device screen to allow users decide whether to watch the full version of the video.

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Aspects of the embodiments will now be presented with reference to systems and methods for generating video preview. These systems and methods will be described in the following detailed description and illustrated in the accompanying drawings by various blocks, components, circuits, steps, operations, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, Central Processing Units (CPUs), digital signal processors (DSPs), field programmable gate arrays (FPGAs), programmable logic devices (PLDs), state machines, gated logic, discrete hardware circuits, and other suitable hardware configured to perform various functions described throughout this disclosure. One or more processors in the processing system may execute software, firmware, or middleware (collectively referred to as “software”). The term “software” shall be construed broadly to mean instructions, instruction sets, code, code segments, program code, programs, subprograms, software components, applications, software applications, software packages, routines, subroutines, objects, executables, threads of execution, procedures, functions, and the like, whether referred to as software, firmware, middleware, microcode, hardware description language, or otherwise.

Accordingly, in one or more exemplary embodiments, the functions described may be implemented in hardware, software, or any combination thereof. If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage, solid state memory, or any other data storage devices, combinations of the aforementioned types of computer-readable media, or any other medium that can be used to store computer executable code in the form of instructions or data structures that can be accessed by a computer.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Moreover, the term “computing device” shall be construed to mean any portable electronic device with a display or image-projecting device, including a mobile device, cellular phone, mobile phone, smartphone, tablet computer, laptop computer, personal digital assistant, music player, multimedia player, portable computing device, game console, smart watch, and so forth. The computing device can also refer to a personal computer, desktop computer, workstation, netbook, network appliance, set top box, server computer, network storage computer, entertainment system, infotainment system, vehicle computer, and the like. Regardless of the implementation, the computing device should include at least one processor, memory, and a display. In some embodiments, the display of computing device can have touchscreen or touch-sensitive capabilities.

The term “video content” shall be construed to mean video data, audio data, audio-visual data, moving images, movies, video clips, or any other digital content or computer data for displaying or playing back by a computing device. The terms “video” and “video content” can be used interchangeably.

Referring now to the drawings, exemplary embodiments are described. The drawings are schematic illustrations of idealized example embodiments. Thus, the example embodiments discussed herein should not be construed as limited to the particular illustrations presented herein, rather these example embodiments can include deviations and differ from the illustrations presented herein.

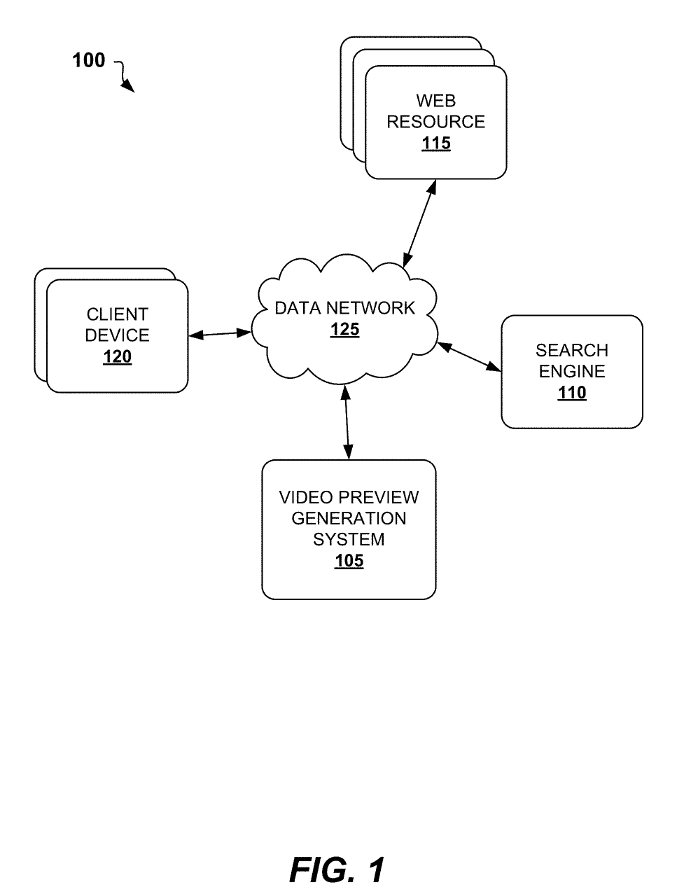

FIG. 1 shows an example embodiment of computer environment 100 for implementing methods for generating video preview as described herein. The computer environment 100 includes a video preview generation system 105, a search engine 110, one or more web resources 115, and one or more client devices 120. The elements of computer environment 100 are operatively connected to each other using one or more data networks 125.

The data network 125 can refer to any wired, wireless, or optical networks including, for example, the Internet, intranet, local area network (LAN), Personal Area Network (PAN), Wide Area Network (WAN), Virtual Private Network (VPN), cellular phone networks (e.g., Global System for Mobile (GSM) communications network, packet switching communications network, circuit switching communications network), Bluetooth radio, Ethernet network, an IEEE 802.11-based radio frequency network, a Frame Relay network, Internet Protocol (IP) communications network, or any other data communication network utilizing physical layers, link layer capability, or network layer to carry data packets, or any combinations of the above-listed data networks. In some embodiments, the data network 125 includes a corporate network, data center network, service provider network, mobile operator network, or any combinations thereof.

The communication between the elements of computer environment 100 can be based on one or more data communication sessions established and maintained using a number of protocols including, but not limited to, Internet Protocol (IP), Internet Control Message Protocol (ICMP), Simple Object Access Protocol (SOAP), Transmission Control Protocol (TCP), User Datagram Protocol (UDP), Hypertext Transfer Protocol (HTTP), Hypertext Transfer Protocol Secure (HTTPS), File Transfer Protocol (FTP), Transport Layer Security (TLS) protocol, Secure Sockets Layer (SSL) protocol, Internet Protocol Security (IPSec), Voice over IP (VoIP), secure video or audio streaming protocols, secure conferencing protocols, secure document access protocols, secure network access protocols, secure e-commerce protocols, secure business-to-business transaction protocols, secure financial transaction protocols, secure collaboration protocols, secure on-line game session protocols, and so forth.

The client devices 120 can include a mobile device, smartphone, tablet computer, personal computer, and the like. The client devices 120 are operated by users, for example, to access web content stored by the web resources 115 or perform searches of web content using the search engine 110. The search engine 110 can include any web service entity configured to index web content, such as webpages, and provide users of client devices 120 with lists of search results (also referred to as results lists) in response to receives search queries.

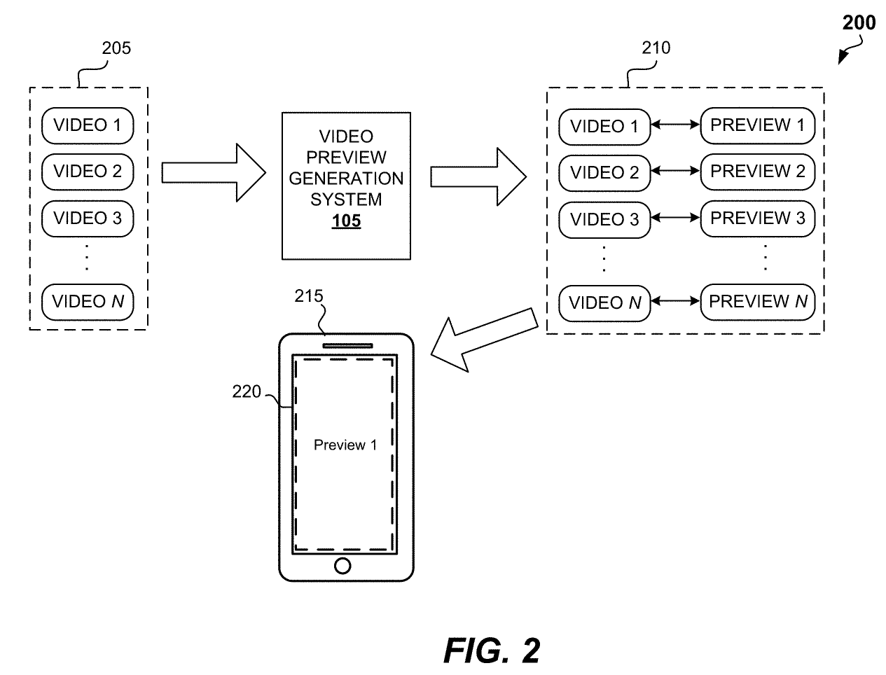

The video preview generation system 105 can be configured to perform generation of previews for videos from a list of videos. As shown in FIG. 2 a list 205 of videos can be provided to video preview generation system 105. The list 205 can be obtained from web resources 115, search engine 110, or client device 120. The videos from the list 205 can be downloaded to a local memory of video preview generation system 105. The system 105 may generate a list 210 including previews for each video from the list 205. The generation of previews can be based on selection of a fragment of a video. The selection can be based on a genre of the video and features of the video using one or more machine-learning algorithms, machine-learning algorithms, probabilistic algorithms, heuristic algorithms, neural network algorithms, and the like. The previews from list 210 can be further provided, via data network 125, to a client device, for example a mobile device 215. The previews can be played back on screen 220 of the mobile device 215. In some embodiments, a user of the mobile device 215 can scroll the list 220 of previews by swiping left and right. To select a full video to be played back on the mobile device 215, the user may swipe down or push a button while watching a preview corresponding to the full video. In response to the selection, the full video may be provided to the mobile device 215 via data network 125.

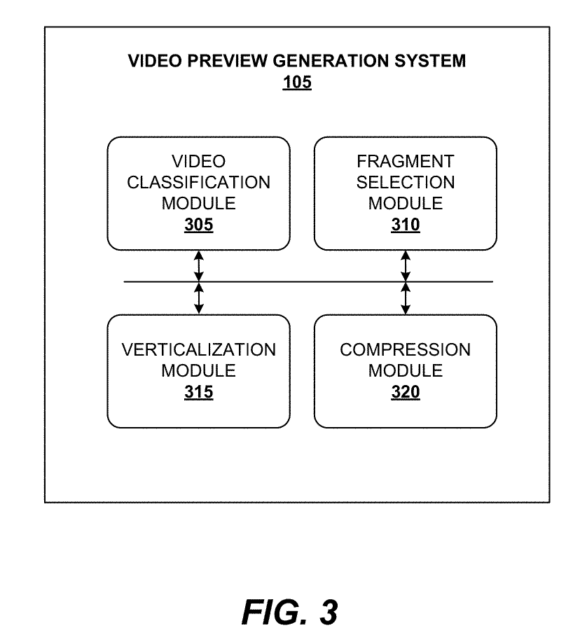

FIG. 3 is a block diagram showing a video preview generation system 105, according to an example embodiment. The video preview system 105 may include a video classification module 305, a fragment selection module 310, a verticalization module 315, and a compression module 320.

In some embodiments, the video classification module 305 may receive a video. The module 305 may extract audio features and video features from the video. The module 305 may further classify the video based on the audio features and the video features. In some embodiments, a result of the classification is obtained using machine learning algorithms run on extracted audio and video features. In certain embodiments, the classification is based on contextual information about the video source and supposed nature of the video. In some embodiments, the contextual information may be obtained from the video source. The contextual information may include the title of video, textual description of video, sizes and resolution of video, and so forth. In other embodiments, the classification can be based on heuristics that can be obtained from a video sequence. The heuristics can be based on the presence of image(s) of people in the video, frequency of scene cuts, overall dynamism of the video, and so forth. The result of the classification may include indicia that the video belong to a certain genre such as, for example, “music”, “video blog”, “news”, “education”, and the like.

In some embodiments, fragment selection module 310 may select a contiguous time fragment of the video. In certain embodiments, the time fragment may be 7 to 20 seconds long. The selection of the time fragment can be performed in such a manner that the selected time fragment is concise but optimally informative of the video content. Alternatively, fragment selection module 310 can decide that the video cannot be confined to the given boundaries without significant loss in quality or substance. In some embodiments, several possible time fragments of video can be selected. Each of the time fragments can be ranked and the highest-ranked fragment can be chosen.

In some embodiments, rank of a time fragment can be determined based on following factors:

a) Maximum difference between values of high-level audio features, such as Mel-frequency cepstral coefficients (MFCC), on inner and outer parts of video near both ends of the fragment;

b) Presence of images of people in frames of the time fragment; In various embodiments, the presence of people can be determined based on one or more face detection algorithms, such as but not limited to, principal component analysis, linear discriminant analysis, support vector machine learning algorithms, hidden Markov model based algorithms, and so forth.

c) Ratio of high-level audio features dispersions on the first seconds of selected fragment and on all preceding parts of the video before the selected fragment. This may allow detecting the audio onset part of the video where the introduction ends and the actual video begins;

d) Information concerning video scenes and scene cut points. In some embodiments, the information concerning cut points can be determined based on a difference heuristics using several consecutive frames of the video. The difference heuristics can be based on a pixel-wise difference and optical flow between the frames; and

e) Factors or audio and video features that can be specific to a certain video class or genre. The factors that are specific to the video class or genre can be used as restrictions on factors or features described in the items a)-d) above.

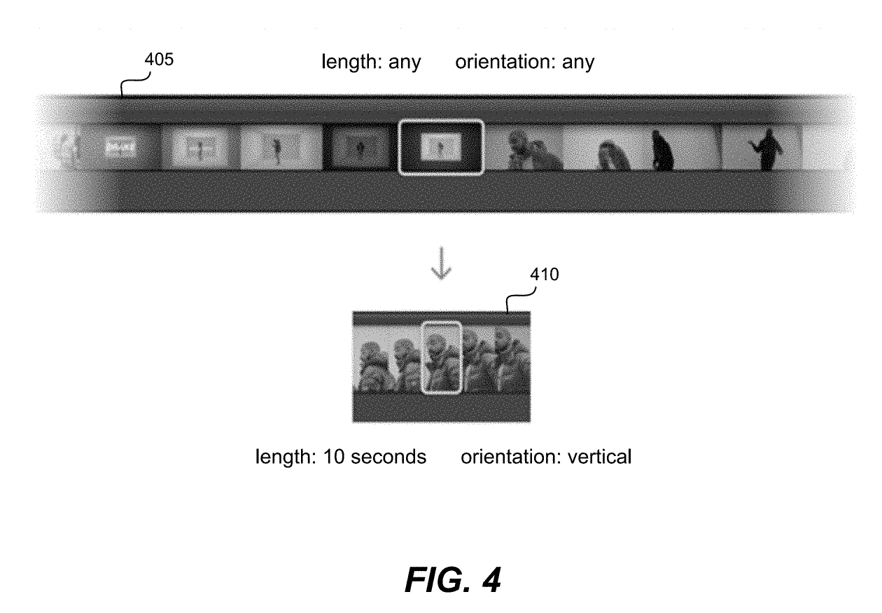

In some embodiments, the verticalization module 315 may crop the selected video fragment to a vertical form to fit a mobile device screen. The module 315 may first break the selected video fragment into scenes using a difference metrics between either consequent frames or frames separated from each other by more than one frame. The module 315 may search for a main object (for example a person) inside each scene. If the main object is found, the module 315 may crop the scene around the main object. FIG. 4 shows scenes 405 of an example video and cropped video fragment 410. If no main object is found within the scene, then the cropping is performed to center around the middle of the original video. As result of the cropping, a snap of the video is created. The snap can be further provided to compression module 320.

Referring back to FIG. 3, compression module 320 can be configured to compress the snap to receive a video preview. The snap can be compressed to several bitrates without using bi-directionally predicted frames and audio interleaved with video in short intervals. The compression of the snap may be useful for mobile applications where the downlink bandwidth is limited. The compression of the snap allows the smooth playback to start shortly after first bytes of video preview are received. Although this makes the video preview file larger, the difference in size is negligible because the video preview is short. Allowing video preview to be shown just as the frame bytes are received may facilitate a smooth playback experience. The video preview can then be played back on a client device as soon as possible, so the user can decide whether it is the right video or swipe to the next preview.

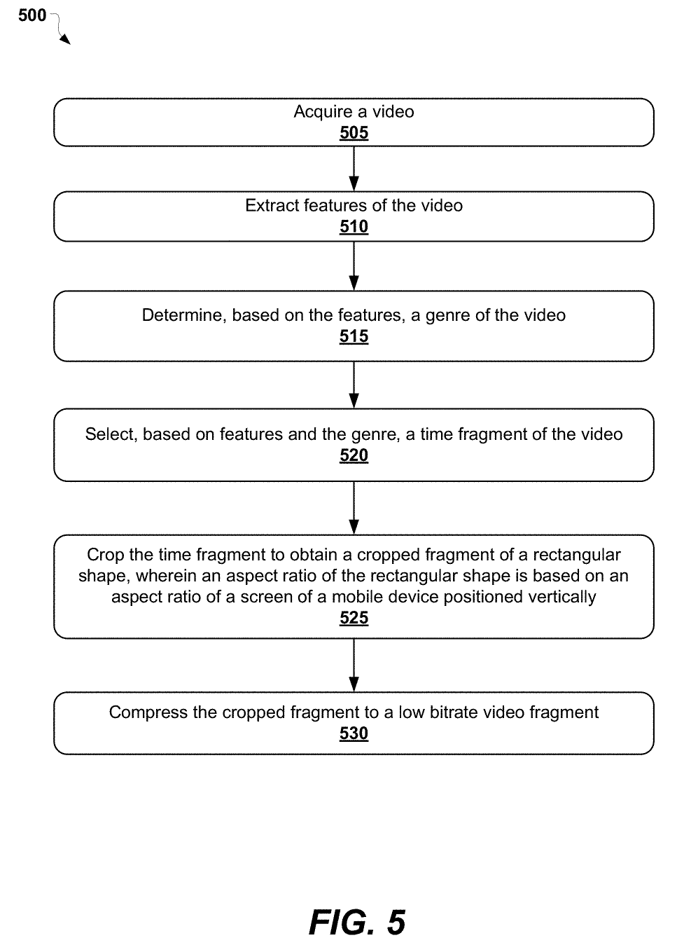

FIG. 5 is a process flow diagram showing a method 500 for generating video previews, according to an example embodiment. Method 500 may be performed by video preview generation system 105. In addition, steps of method 500 may be implemented in an order different than described and shown in the figure. Moreover, method 500 may have additional steps not shown herein, but which can be evident for those skilled in the art from the present disclosure.

Method 500 may commence in block 505 with acquiring a video. In block 510, method 500 may include extracting features of the video. The extracted features may include audio features and video features. The audio features may include the high-level audio features, such as Mel-frequency cepstral coefficients (MFCC).

In block 515, method 500 may include determining, based on the features, a genre of the video. In block 520, method 500 may allow selecting, based on the features and the genre, a time fragment of the video. In some embodiments, the time fragment can be selected from a several possible time fragments. Each of the possible time fragments can be ranked based on the fragment features. The fragment having the highest rank is the selected for further processing. In certain embodiments, the rank of the possible time fragment is determined based on changes in high-level audio features determined inside and outside of the time fragment, at both ends of the time fragment. A larger change receives the larger rank. The rank of the possible time fragment can be also determined based on the presence of images of people in the frames of the time fragment.

In block 525, method 500 may include cropping the time fragment to a rectangular shape. The aspect ratio of the rectangular shape can be based on the aspect ratio of a screen of a mobile device when it is positioned vertically.

In block 530, method 500 may proceed with compression of the cropped time fragment into a low bitrate video fragment.

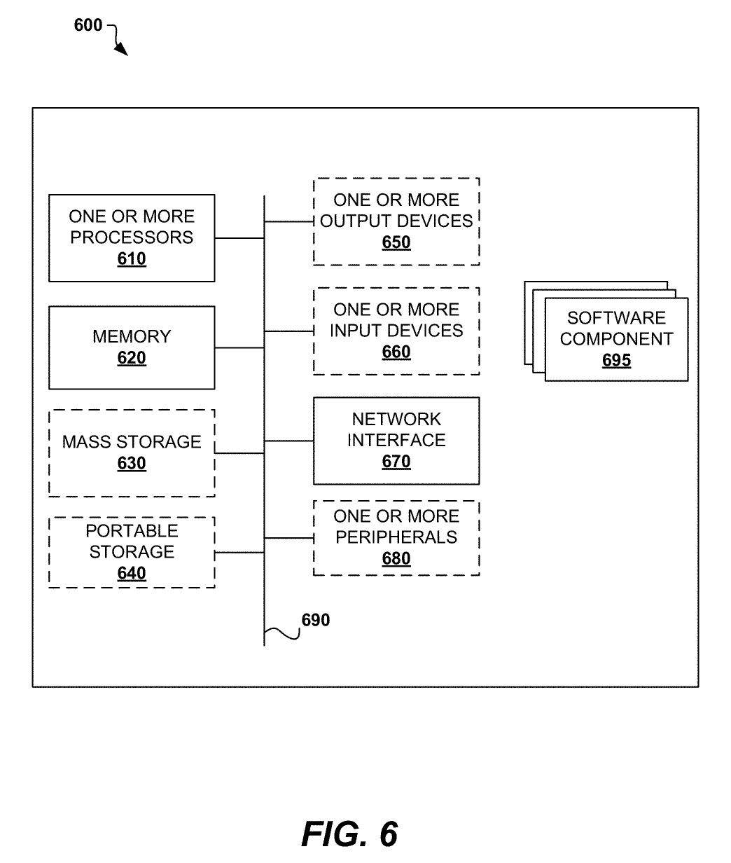

FIG. 6 illustrates an example computing system 600 that may be used to implement methods described herein. The computing system 600 may be implemented in the contexts of the likes of the video preview generation system 105, search engine, 110, web resource 115, client device 120, video classification module 305, fragment selection module 310, verticalization module 315, or compression module 320.

As shown in FIG. 6, the hardware components of the computing system 600 may include one or more processors 610 and memory 620. Memory 620 stores, in part, instructions and data for execution by processor 610. Memory 620 can store the executable code when the system 600 is in operation. The system 600 may further include an optional mass storage device 630, optional portable storage medium drive(s) 640, one or more optional output devices 650, one or more optional input devices 660, a network interface 670, and one or more optional peripheral devices 680. The computing system 600 can also include one or more software components 695.

The components shown in FIG. 6 are depicted as connected via a single bus 690. The components can be connected through one or more data transport means or data network. The processor 610 and memory 620 can be connected via a local microprocessor bus and the mass storage device 630, peripheral device(s) 680, portable storage device 640, and network interface 670 may be connected via one or more input/output (I/O) buses.

The mass storage device 630, which may be implemented with a magnetic disk drive, solid-state disk drive, or an optical disk drive, is a non-volatile storage device for storing data and instructions for use by the processor 610. Mass storage device 630 can store the system software (e.g., software components 695) for implementing embodiments described herein.

Portable storage medium drive(s) 640 operates in conjunction with a portable non-volatile storage medium, such as a compact disk (CD), or digital videodisc (DVD), to input and output data and code to and from the computer system 600. The system software (e.g., software components 695) for implementing embodiments described herein may be stored on such a portable medium and input to the computer system 600 via the portable storage medium drive(s) 640.

The optional input devices 660 provide a portion of a user interface. The input devices 660 may include an alphanumeric keypad, such as a keyboard, for inputting alphanumeric and other information, or a pointing device, such as a mouse, a trackball, a stylus, or cursor direction keys. Additionally, the system 600 as shown in FIG. 6 includes optional output devices 650. Suitable output devices include speakers, printers, network interfaces, and monitors.

The network interface 670 can be utilized to communicate with external devices, external computing devices, servers, and networked systems via one or more communications networks such as one or more wired, wireless, or optical networks including, for example, the Internet, intranet, LAN, WAN, cellular phone networks, Bluetooth radio, and an IEEE 802.11-based radio frequency network, among others. The network interface 670 may be a network interface card, such as an Ethernet card, optical transceiver, radio frequency transceiver, or any other type of device that can send and receive information. The optional peripherals 680 may include any type of computer support device to add additional functionality to the computer system.

The components contained in the computer system 600 of FIG. 6 are those typically found in computer systems that may be suitable for use with embodiments described herein and are intended to represent a broad category of such computer components that are well known in the art. Thus, the computer system 600 can be a server, personal computer, hand-held computing device, telephone, mobile computing device, workstation, minicomputer, mainframe computer, network node, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium or processor-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a processor for execution. Such media can take many forms, including, but not limited to, non-volatile media, volatile media, and transmission media. Non-volatile media include, for example, optical or magnetic disks, such as a fixed disk. Volatile media include dynamic memory, such as system random access memory (RAM). Transmission media include coaxial cables, copper wire, and fiber optics, among others, including the wires that include one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, any other memory chip or cartridge, a carrier wave, or any other medium from which a computer can read.

Various forms of computer-readable media may be involved in carrying one or more sequences of one or more instructions to a processor for execution. A bus carries the data to system RAM, from which a processor retrieves and executes the instructions. The instructions received by system processor can optionally be stored on a fixed disk either before or after execution by a CPU.

Thus, systems and methods for generating video previews have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for generating a video preview, the method comprising:
acquiring a video;
extracting features of the video;
determining, based on the features, a genre of the video; and
selecting, based on the features and the genre, a time fragment of the video.

2. The method of claim 1, wherein selecting the time fragment includes:
selecting portions of the video;
determining features of at least one portion from the portions;
determining, based on the features of the at least one portion, a rank of the at least one portion;
based on the rank of the at least one portion, determining a highest ranked portion from the portions; and
designating the highest ranked portion as the time fragment.

3. The method of claim 2, wherein the features of the at least one portion include high-level audio features.

4. The method of claim 3, wherein the high-level audio features includes Mel-frequency cepstral coefficients (MFCC).

5. The method of claim 3, wherein the rank of the at least one portion is determined based on a maximum difference between the high-level audio features determined inside the at least one portion and outside of the at least one portion.

6. The method of claim 3, wherein the rank of the at least one portion is determined based on a ratio of dispersions of the high-level audio features determined at first seconds of the at least one portion and a portion of the video preceding the at least one portion.

7. The method of claim 2, wherein the rank of the at least one portion is determined based on the presence of images of people within the at least one portion.

8. The method of claim 1, further comprising cropping the time fragment to obtain a cropped fragment of a rectangular shape, wherein an aspect ratio of the rectangular shape is based on an aspect ratio of a screen of a mobile device positioned vertically.

9. The method of claim 8, further comprising compressing, based on a predetermined video format, the cropped fragment to obtain a low bitrate fragment.

10. The method of claim 1, wherein a duration of the time fragment is in a range between 7 seconds to 20 seconds.

11. A system for generating a video preview, the system comprising:
at least one processor; and
a memory storing processor-executable codes, wherein the at least one processor is configured to implement the following operations upon executing the processor-executable codes:
acquiring a video;
extracting features of the video;
determining, based on the features, a genre of the video; and
selecting, based on the features and the genre, a time fragment of the video.

12. The system of claim 11, wherein selecting the time fragment includes:
selecting portions of the video;
determining features of at least one portion from the portions;
determining, based on the features of the at least one portion, rank of the at least one portion;
based on the rank of the at least one portion, determining a highest ranked portion from the portions; and
designating the highest ranked portion as the time fragment.

13. The system of claim 12, wherein the features of the at least one portion include high-level audio features.

14. The system of claim 13, wherein the high-level audio features includes Mel-frequency cepstral coefficients (MFCC).

15. The system of claim 13, wherein the rank of the at least one portion is determined based on a maximum difference between the high-level audio features determined inside the at least one portion and outside of the at least one portion.

16. The system of claim 13, wherein the rank of the at least one portion is determined based on a ratio of dispersions of the high-level audio features determined at first seconds of the at least one portion and a portion of video preceding the at least one portion.

17. The system of claim 12, wherein the rank of the at least one portion is determined based on the presence of images of people within the at least one portion.

18. The system of claim 11, wherein the at least one processor is further configured to implement cropping of the time fragment to obtain a cropped fragment of a rectangular shape, wherein an aspect ratio of the rectangular shape is based on an aspect ratio of a screen of a mobile device positioned vertically.

19. The system of claim 18, wherein the at least one processor is further configured to implement compressing, based on a predetermined video format, the cropped fragment to obtain a low bitrate fragment.

20. A non-transitory processor-readable medium having instructions stored thereon, which when executed by one or more processors, cause the one or more processors to implement a method for controlling video playback, the method comprising:
acquiring a video;
extracting features of the video;
determining, based on the features, a genre of the video; and
selecting, based on the features and the genre, a time fragment of the video.
